(19) United States
(12) Patent Application Publication
(10) Pub. No.: US 2025/0342344 A1
(43) Pub. Date: Nov. 6, 2025

(54) RETRIEVAL AUGMENTED GENERATION OVER GRAPH NEURAL NETWORK FOR EDGE BUILDING

(71) Applicant: Microsoft Technology Licensing, LLC, Redmond, WA (US)

(72) Inventors: Siyuan GAO, San Mateo, CA (US); Parag AGRAWAL, Santa Clara, CA (US); Aman GUPTA, San Jose, CA (US); Ankan SAHA, New York, NY (US); Viral GUPTA, Lathrop, CA (US)

(21) Appl. No.: 18/651,784

(22) Filed: May 1, 2024

(51) Int. Cl. G06N 3/0455; G06N 3/0499

(52) U.S. Cl. CPC G06N 3/0455; G06N 3/0499

(57) ABSTRACT

Aspects of the disclosure include methods for leveraging retrieval augmented generation (RAG) over a graph neural network (GNN) for edge building and the generation of reason-aware graph recommendations. A method can include constructing a graph neural network from an input graph having a plurality of nodes and one or more edges. The graph neural network includes one or more internal layers, each internal layer having one or more node vectors encoding a K-hop neighborhood for a target node of the plurality of nodes. RAG data including non-graph contextual data is retrieved for each of the plurality of nodes and transformed into embeddings using a large language model encoder. The RAG embeddings are encoded into node vectors of the graph neural network. The graph neural network generates a representation for the target node that is transformed by a feed forward neural network tower into an output vector.

### INTRODUCTION

The subject disclosure relates to machine learning, networks, pattern recognition, and data discovery, and specifically to the use of retrieval augmented generation (RAG) over a graph neural network (GNN) for edge building and the generation of reason-aware graph recommendations.

### A BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the present disclosure are apparent from the following detailed description taken in conjunction with the accompanying drawings in which:

FIG. 1 depicts a block diagram for a retrieval augmented generation-graph neural network (RAG-GNN) hybrid system in accordance with one or more embodiments.

FIG. 2 depicts an example input graph for the RAG-GNN hybrid system of FIG. 1 in accordance with one or more embodiments;

FIG. 3 depicts a block diagram for a recommendation system in accordance with one or more embodiments;

FIG. 4 depicts a block diagram for a recommendation service in accordance with one or more embodiments;

FIG. 5 depicts a block diagram of a computer system according to one or more embodiments;

FIG. 6 depicts a flowchart of a method in accordance with one or more embodiments; and

FIG. 7 depicts an example transformer-based architecture for a large language model in accordance with one or more embodiments.

The diagrams depicted herein are illustrative. There can be many variations to the diagram or the operations described therein without departing from the spirit of this disclosure. For instance, the actions can be performed in a differing order or actions can be added, deleted or modified.

In the accompanying figures and following detailed description of the described embodiments of this disclosure, the various elements illustrated in the figures are provided with two or three-digit reference numbers. With minor exceptions, the leftmost digit(s) of each reference number corresponds to the figure in which its element is first illustrated.

### DETAILED DESCRIPTION

### Overview

Algorithmic content recommendation systems are sophisticated technology platforms designed to provide users with personalized suggestions for relevant content. These types of systems often rely on advanced algorithms to analyze user data, preferences, and contextual information to generate tailored content recommendations. Algorithmic content recommendation systems can be employed in various digital platforms, such as streaming services, e-commerce websites, social media platforms, and news websites, to enhance user engagement by delivering content tailored to individual preferences and behaviors. For example, an algorithmic content recommendation system might, in the context of a connections network, serve recommendations (also referred to as impressions) for people and content, such as a list of people to reach out to, videos to watch, articles to read, learning courses and resources to consider, etc.

One of the key challenges in a content recommendation system is the identification and selection of high-quality impressions (that is, recommendations that are of actual interest to the served party). While many approaches are possible, graph neural networks (GNNs) have emerged as a powerful tool in algorithmic content recommendation systems, particularly in the context of recommending relevant people and connections in social networks. The ability of GNNs to learn rich representations from graph-structured data makes them well-suited for modeling the complex relationships and interactions within a network, which can be considered as having a graph structure with users represented as nodes and their connections (e.g., friendships, follows, interactions, etc.) as edges.

A GNN architecture can be leveraged to learn user representations that encode both the user's individual features and the structural patterns within their social neighborhood. The message passing mechanism of GNNs allows information to propagate across the graph, capturing higher-order relationships and similarities between users based on their connections and the connections of their neighbors. Thus, a content recommendation impression in this context can mean the identification and serving (via, e.g., an impression) of a new edge to a user within the underlying network.

Unfortunately, while GNN-based recommendations robustly capture a member's network topology, these systems fail to capture additional contextual information that might be highly relevant, such as the textual behavior of a member. Consider, for example, a member that interacts with the content of other members, lists the relevant skills he or she possesses on their profile, and shares his or her interests and competencies in a profile description. These data are very high quality signals that can capture a member's interests and intent, and notably, these data are not natively captured in the network graph. In short, a GNN-based system alone does not provide a systematic way to capture a member's network topology and additional contextual signals simultaneously.

This disclosure introduces the use of retrieval augmented generation (RAG) over a graph neural network (GNN) for edge building and the generation of reason-aware graph recommendations. Rather than relying on a GNN-based architecture alone for making recommendations (edge finding), a RAG-GNN hybrid architecture is described herein that simultaneously considers both a member's network topology and any subset of additional contextual information to generate high quality recommendations that reflect not only the member's graph neighborhood but also their interests, intents, interactions, etc.

In some embodiments, a RAG subsystem retrieves non-graph contextual data, referred to herein as RAG data, that is then encoded into node features of a GNN architecture. As used herein, “non-graph contextual data” is contextual data that is not network topology data (that is, data which is not natively captured within the topology of a GNN). For example, node features for a respective node can include user profile data such as stated interests, demographics, textual interactions with other users, skills, titles, and other relevant information (e.g., “about me . . . ”). In some embodiments, a pre-trained large language model is leveraged to generate encodings for the RAG data, and these encodings are then encoded into the node features of the respective node within the GNN architecture. The encoded nodes can then propagate through the K-hop layers of the GNN architecture, ultimately resulting in an output vector that leverages graph network data and non-graph contextual data simultaneously.

Incorporating a RAG subsystem within a GNN architecture as described herein solves a number of somewhat related technical issues with current content recommendation systems. First, recommendation systems built from GNN architectures or RAG architectures alone are natively limited. In particular, GNN architectures are inherently vulnerable to the so-called graph isomorphism problem and RAG architectures are inherently vulnerable to so-called hallucinations. A RAG-GNN hybrid architecture can be constructed to solve both of these problems concurrently.

To illustrate, consider that a pure GNN based (graph based) recommender system tends to recommend edges (e.g., potential member connections in a network) to nodes (e.g., other members) having similar network topographies, even when those respective members might have completely different interests, intents, etc. For example, a member who is a doctor might get recommended to a member who is an engineer solely because those members have similar network topologies. A novel aspect of the present RAG-GNN hybrid architecture is that a hybrid system can leverage the RAG subsystem to mitigate the graph isomorphism problem by mining textual signals that ultimately identify that this doctor has different interests and/or intents from this engineer. That is, a potential edge recommendation sourced from GNN features (network topology similarity, etc.) can be discarded based on RAG data.

Similarly, a pure RAG based recommender system tends to recommend edges (e.g., potential member connections in a social network) to nodes (e.g., members) having similar interests, intents, etc., without regard to the network topographies of those respective members. For example, a member who is in a different country might be recommended to another member solely because those members have textually similar interests and/or intents. These types of recommendations are known as hallucinations, as they appear to be reasonable recommendations when RAG data is considered in a vacuum. A novel aspect of the present RAG-GNN hybrid architecture is that a hybrid system can leverage the GNN architecture to capture any differences in network topology to reduce such false recommendations, thereby mitigating the hallucination problem. That is, a potential edge recommendation sourced from RAG data can be discarded when the network factual evidence embedded by the GNN shows that such a recommendation is not likely to be relevant, even though there are similarities in RAG data. Other advantages are possible.

A RAG-GNN hybrid architecture can mine both network and textual information simultaneously in a manner that is dynamically complementary. For instance, for under-connected members (e.g., members having low edge count, for any predetermined threshold number of edges), a RAG-GNN hybrid architecture can rely on their textual behavior to show high quality recommendations, while for less active members (e.g., members having little RAG data, for any predetermined threshold amount of data), the same RAG-GNN hybrid architecture can rely on the member's network neighborhoods to show relevant recommendations. On the other hand, for sufficiently and/or over-connected members (e.g., members having an edge count greater than any predetermined threshold number of edges), the RAG-GNN hybrid architecture can be used to effectively prune their noisy network by identifying their most informative sub-network via textual signals.

Not only does a RAG-GNN hybrid architecture generate high quality graph recommendations, such a system can be constructed to surface the reason behind such recommendations. For example, in some embodiments, the output of the RAG-GNN hybrid architecture is coupled to one or more feed forward neural network towers through a loss function. In some embodiments, one of the feed forward neural network towers encodes a query (itself a user query and/or predetermined query). For example, a user query might be “please recommend me people nearby with an interest in machine learning”). In this configuration, the overall recommendation system can identify the edge(s) that are most appropriate (via minimizing the loss function) for that particular query. Advantageously, such a configuration allows for the reason for the recommendation to be provided alongside the recommendation itself. For example, an output might be “Member A, we recommend member B because member B lives in your community and is also interested in machine learning”. Thus, the RAG-GNN hybrid architecture described herein can provide reason-aware graph recommendations.

### DETAILED EMBODIMENT

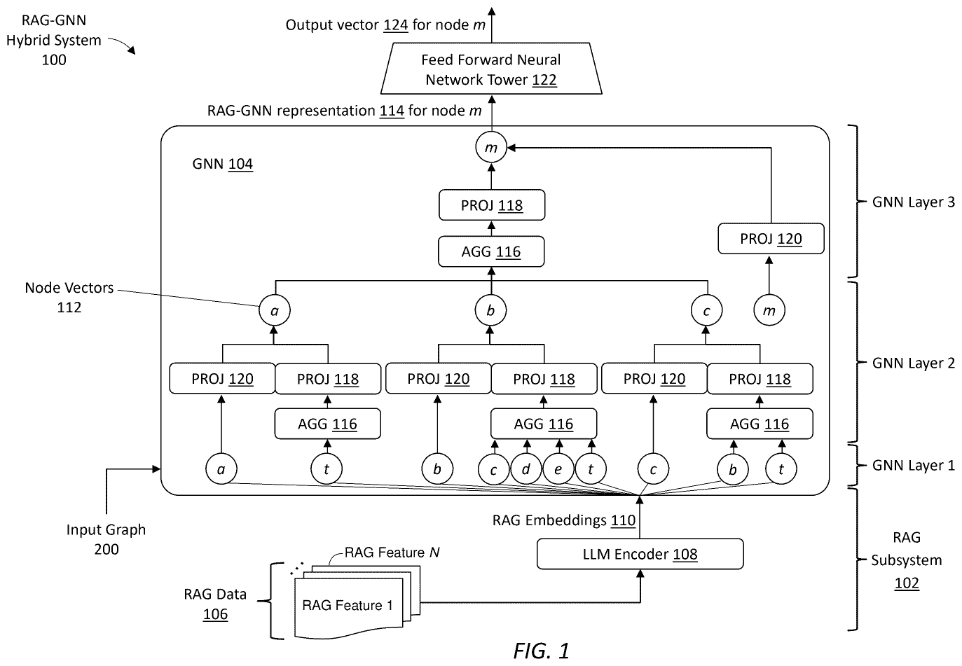

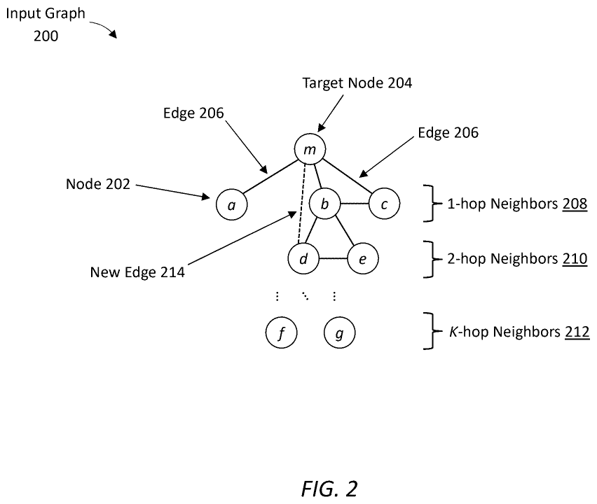

FIG. 1 depicts a block diagram for a RAG-GNN hybrid system 100 in accordance with one or more embodiments. FIG. 2 depicts an example input graph 200 for the RAG-GNN hybrid system 100 of FIG. 1 in accordance with one or more embodiments.

As shown in FIG. 1, the RAG-GNN hybrid system 100 includes a RAG subsystem 102 coupled to a GNN 104. The RAG-GNN hybrid system 100, the RAG subsystem 102, and/or the GNN 104 can each be stored and/or implemented on cloud, on a client device(s), or on a combination thereof.

In some embodiments, the RAG subsystem 102 is configured to receive and/or retrieve RAG data 106, which can include any number of predetermined RAG features (e.g., RAG Feature 1, RAG Feature 2, . . . , RAG Feature N for any N). The RAG data 106 is not meant to be particularly limited, and can include, for example, non-graph contextual data for one or more nodes of the GNN 104. Continuing with the prior example of a social network, the RAG data 106 for a given member/node might include textual data found within the respective member's social network profile. Such data might include, for example, textual data pertaining to that respective member's self- or community-reported skillset (referred to as “skill text”), textual data defining the respective member's current and/or past job title(s) (referred to as “title text”), and/or textual data describing the respective member's interests, likes, goals, etc. (referred to as a “description text”).

In some embodiments, the RAG subsystem 102 is coupled to one or more external data sources (not separately shown). For example, in some embodiments, the RAG subsystem 102 can be coupled to account and/or profile data of members of a connections network. The external data sources are not meant to be particularly limited and can include, for example, Web page(s) and/or Web page metadata repositories, online and/or private databases, text corpora, such as news articles, books, and published research papers, social media data, knowledge graphs, user-generated content such as forum posts, discussion boards, etc., domain-specific databases such as for medical records, legal documents, and financial reports, and/or multimodal data repositories such as images, video, and audio media platforms.

In some embodiments, the RAG subsystem 102 filters a complete space of possible RAG data to a subset of the available data that defines the RAG data 106. In some embodiments, the RAG subsystem 102 is configured via cross-validation to select the most applicable data and/or data types from the external data sources for the RAG data 106. In some embodiments, the RAG subsystem 102 is pre-configured via cross-validation using different subsets of the available data. In some embodiments, cross-validation includes selecting a subset of the available data, determining the performance of the RAG-GNN hybrid system 100 on that dataset, repeating for new subsets of the available data, and identifying, empirically, which selected subsets of data and/or data types resulted in the highest performance (against any predetermined metric of interest, such as, e.g., prediction accuracy, inference latency, etc., as desired). Continuing with the prior example of a connections network, user profiles are rich textual data-sources that include descriptions, profile data, self or peer reported skills, geographic information, language, school associations, degrees, work history, publications, and other accomplishments and the RAG subsystem 102 can be configured via cross-validation to identify which data types provide the highest level of performance. For example, cross-validation can show that the data subset including peer reported skills, work history, and publications provides the highest performance metric(s). In this manner, only a subset of all possible RAG data 106 is required, lowering the raw amount of data required for training and/or inference using the RAG-GNN hybrid system 100.

In some embodiments, the RAG-GNN hybrid system 100 leverages a pre-trained large language model (LLM) to generate, from the RAG data 106, RAG embeddings 110. More specifically, in some embodiments, the RAG-GNN hybrid system 100 leverages an LLM encoder 108 to generate the RAG embeddings 110.

While not meant to be particularly limited, the LLM and/or LLM encoder 108 can include a neural network machine learning architecture that is capable of processing large amounts of text data and generating high-quality natural language responses. In practice, large language models have been used for a wide range of natural language processing (NLP) tasks, including, for example, machine translation, text generation, sentiment analysis, and question answering (i.e., query-and-response). Large language models have also been adapted for other domains, such as computer vision, speech recognition, and software development.

At its core, a large language model consists of an encoder and a decoder. The encoder takes in a sequence of input tokens, such as words or characters, and produces a sequence of hidden representations for each token that capture the contextual information of the input sequence. The decoder then uses these hidden representations, along with a sequence of target tokens, to generate a sequence of output tokens.

The most popular and widely used types of large language models are recurrent neural networks (RNNs) and transformers. RNNs are neural networks that process sequences of inputs one by one, and use a hidden state to remember previous inputs. RNNs are particularly well-suited for tasks that involve sequential data, such as text, audio, and time-series data. In a transformer, on the other hand, the encoder and decoder are composed of multiple layers of multi-headed self-attention and feedforward neural networks. The core of the transformer model is the self-attention mechanism, which allows the model to focus on different parts of an input sequence at different timesteps, without the need for recurrent connections that process the sequence one by one. Transformers leverage self-attention to compute representations of input sequences in a parallel and context-aware manner and are well-suited to tasks that require capturing long-range dependencies between words in a sentence, such as in language modeling and machine translation.

Large language models are typically trained on large amounts of text data, often containing hundreds of millions if not billions of words. To handle the large amount of data, the training process is often highly parallelized. The training process can take several days or even weeks, depending on the size of the model and the amount of training data involved. Large language models can be trained using backpropagation and gradient descent, with the objective of minimizing a loss function such as cross-entropy loss.

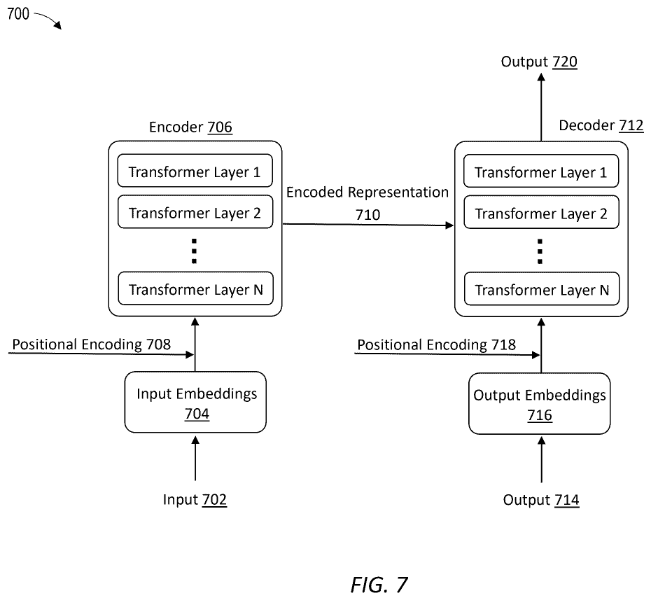

FIG. 7 illustrates an example transformer-based architecture 700 for a large language model. As shown in FIG. 7, the transformer-based architecture 700 begins with an input 702. The input 702 denotes an input text provided by a user (or upstream system) and can be represented as a sequence of tokens, individual words or sub-words, from which input embeddings 704 can be generated. The input embeddings 704 represent the tokens within the input 702 as numbers, which can be processed using an encoder 706. In some embodiments, a positional encoding 708 can be generated to encode the position of each token in input 702 as a set of numbers. These numbers can be fed into the encoder 706 (e.g., the LLM encoder 108) with the input embeddings 704, allowing the transformer-based architecture 700 to more effectively understand the order of words in a sentence and to thereby generate grammatically correct and semantically meaningful outputs.

The encoder 706 processes the input embeddings 704 and the positional encoding 708 and generates, for the input 702, an encoded representation 710 that captures the meaning and context of the input 702. To accomplish this, encoder 706 applies a series of self-attention transformer layers (or simply, “transformer layers”), which are a series of hidden states that represent the input 702 at different levels of abstraction. The encoder 706 can include any number of these transformer layers, as desired. The encoded representation 710 is provided to a decoder 712.

The decoder 712 similarly includes a number of transformer layers, as desired, except that the decoder 712 processes an output 714. In most implementations, the output 714 is a right-shifted copy of the input 702, meaning that the decoder 712 can only use the previous words for next-word prediction. In some embodiments, output embeddings 716 can be generated from the output 714 to represent the tokens in the output 714 as numbers, in a similar manner as described with respect to the encoder 706. A positional encoding 718 can be added to the output embeddings 716 to encode the position of each token in output 714 as a set of numbers. The decoder 712 can be trained by minimizing a loss function (also known as an objective function, which quantifies a difference between a predicted output and a known true value) using, for example, gradient descent. Once trained, the transformer-based architecture 700 can be used during a so-called inference phase to generate an output 720, which can be thought of as a next-word probability (that is, how likely is the next word in the sequence to be x, or y, etc.). In some configurations, the transformer-based architecture 700 includes a linear layer and SoftMax layer (omitted for clarify) to transform a raw output from the decoder 712 into the output 714. For example, after the decoder 712 produces a raw output (e.g., output embeddings), the linear layer can map the output embeddings to a higher-dimensional space, thereby transforming the output embeddings into a same original input space as the input 702. The SoftMax function can be used to generate a probability distribution for each output token in the vocabulary, enabling the transformer-based architecture 700 to generate output tokens with probabilities (e.g., the output 720).

Returning to FIG. 1, in some embodiments, the RAG embeddings 110 are encoded into respective node vectors 112 (also referred to as RAG-encoded feature vectors) of the GNN 104. In some embodiments, the node vectors 112 propagate through one or more layers of the GNN 104, resulting in the generation of a hidden, latent representation vector 114 (also referred to as a RAG-GNN representation for node m). To illustrate, consider the RAG-GNN hybrid system 100 of FIG. 1 in combination with the input graph 200 of FIG. 2.

In some embodiments, the input graph 200 is a known and/or existing graph having a plurality of nodes 202 (as shown, nodes m, a, b, c, d, e, f and g). In some embodiments, node m (m for “member”) represents a target node 204 for the input graph 200. The nodes m, a, b, c, d, e, f and g are coupled via a combination of edges 206. Thus, the input graph 200 might represent the current connectivity of a respective member (denoted by the target node 204) with respect to one or more other members within a network. It should be understood that the input graph 200 is merely illustrative. The number of nodes, their relative positions, and their connectivity (that is, the number and placement of edges) will vary and all such configurations are within the contemplated scope of this disclosure.

In some embodiments, one or more layers of the GNN 104 are built from the input graph 200 and the RAG embeddings 110. In some embodiments, one or more layers of the GNN 104 are constructed using an iterative K-hop process starting from the target node 204 (node m). First, a sample of the 1-hop neighborhood for the target node 204 can be identified within the input graph 200. The sample can include any subset (including all, or some) of the 1-hop neighbors 208 of the target node 204. Next, this process is repeated recursively for each of the 1-hop neighbors 208 to generate their own sample (again, including all or some) of 1-hop neighbors. Observe that the 1-hop neighbors of the 1-hop neighbors 208 are the 2-hop neighbors 210 for node m. Now, this process can be repeated again recursively for each of the 2-hop neighbors 210, and again as many times as desired, until the K-hop neighborhood for node m is complete for any K. In other words, the process can be recursively repeated as desired until the K-hop neighbors 212 of node m are generated for some predetermined value for K.

In some embodiments, the layers of the GNN 104 are constructed from the discovered K-hop neighborhood for node m. In some embodiments, the nodes 202 of the highest K-neighborhood of the input graph 200 are assigned to a first layer (as shown, GNN Layer 1) of the GNN 104. In other words, in some embodiments, all of the sampled nodes within the K-neighborhood are assigned to the first layer. For example, the nodes m, a, b, c, d, and e form a 2-hop neighborhood for node m when K is 2 (omitting further potential layers and nodes f and g for simplicity), and all of these nodes can be assigned to GNN Layer 1.

The next layer (as shown, GNN Layer 2) of GNN 104 encodes the next highest (K−1)-neighborhood of the input graph 200. Continuing with the prior example, GNN Layer 2 encodes the 1-hop neighborhood for node m when K is 2. Similarly, the last layer (as shown, GNN Layer 3) of GNN 104 encodes the 0-neighborhood of the input graph 200, which is simply the node m. Of course, this process can be repeated as many times as needed, depending on the initial value for K.

Once the total number of layers of the GNN 104 and the assignments of the K-neighborhood nodes are known, each of the node vectors 112 within GNN 104 can be encoded with the RAG embeddings 110, thereby providing a RAG-GNN hybrid architecture. In some embodiments, starting at the first layer of GNN 104 (as shown, GNN Layer 1 for the 2-hop neighborhood of the input graph 200), for each node 202, respective RAG features (e.g., skill text, title text, description text, etc.) are retrieved, encoded using the LLM encoder 108 into RAG embeddings 110, and concatenated into the respective node vector 112. In other words, each node vector 112 represents the encoded and concatenated RAG features for their respective node 202 in the input graph 200.

In some embodiments, the node vectors 112 for successive layers of the GNN 104 are built by aggregating the node vectors 112 from lower layers of the GNN 104 depending on the respective connectivity of the underlying nodes 202 in the input graph 200. In some embodiments, aggregator modules 116 are configured to transform the encoded and concatenated RAG features via an aggregation operation. An aggregation operation refers to the process of combining the feature vectors (representations) of a node's neighbors. While not meant to be particularly limited, an aggregation operation can include a permutation-invariant function, such as, for example, sum, mean, and/or max pooling. For example, if a node v has neighbors u₁, u₂, . . . , uₙ with feature vectors hᵤ₁, hᵤ₂, . . . , hᵤₙ, respectively, the aggregation operation can combine these neighbor features into a single aggregate feature vector, denoted as AGG(hᵤ₁, hᵤ₂, . . . , hᵤₙ). Continuing with the prior example, the node vectors 112 for nodes c, d, e, and t in GNN Layer 1 can be aggregated using an aggregator module 116 (as shown, “AGG 116”) in GNN Layer 2. In another example, the node vectors 112 for nodes a, b, and c in GNN Layer 2 can be aggregated using an aggregator module 116 (as shown, “AGG 116”) in GNN Layer 3. In other words, each node vector 112 in successive layers of the GNN 104 can be built by aggregating the encoded and concatenated node vectors 112 of their neighborhood.

In some embodiments, the intermediate output (not separately indicated) from each AGG 116 is passed to a linear projection module 118 (as shown, “PROJ 118”). In some embodiments, the linear projection module 118 is configured to transform the AGG 116 output using a linear projection. The linear projection operation allows changing the dimensionality of the node vectors 112 and/or their aggregated neighbor representations (for higher GNN layers). The linear projection module 118 can be used when input and output feature dimensions are different and/or when working with high-dimensional features (for any predetermined dimensionality), as desired. While not meant to be particularly limited, a linear projection can be implemented as a linear transformation using a weight matrix (a so-called projection matrix) and a bias term according to the following formula (1):

$$PROJ ( h ) = W * h + b \qquad ( 1 )$$

where h is the input feature vector, W is the projection weight matrix, and b is the bias vector.

In some embodiments, the intermediate output (not separately indicated) from each linear projection module 118 is combined with the output of a separate linear projection module 120 (as shown, “PROJ 120”). In some embodiments, the linear projection module 120 is configured to output a linear projection of the respective node from the preceding layer of GNN 104. For example, for the node b in GNN Layer 2, the PROJ 118 can be combined with the PROJ 120 for node b in GNN Layer 1.

Accordingly, in some embodiments, the node vectors 112 of GNN Layer 1 (that is, the Layer 1 embeddings) are of the form hₘ⁰=xₘ, where xₘ denotes the concatenated RAG Embeddings 110 from the LLM Encoder 108 for member m of the input graph 200. In some embodiments, the node vectors 112 of the last GNN layer (that is, the K^{th} layer, or the Layer 3 embeddings in the present example) are of the form hₘ^{last}=zₘ, where zₘ denotes representation vector 114 (that is, the RAG-GNN hybrid system 100 representation for node m of the input graph 200). In some embodiments, the node vectors 112 of intermediate GNN layers (that is, the Layer 2 embeddings in the present example) are of the form

$${h}_{m}^{k} = tan h ( {W}_{k} \cdot {\sum }_{u ∈ N ( m )} \frac{{h}_{u}^{k - 1}}{\vert N ( m ) \vert} + {B}_{k} \cdot {h}_{m}^{k - 1} ) ,$$

where Wₖ denotes the projection weight matrix for layer k, N(m) is the neighborhood for node m, Bₖ is the bias vector, and tanh is a non-linear activation function. Thus,

$${W}_{k} \cdot {\sum }_{u ∈ N ( m )} \frac{{h}_{u}^{k - 1}}{\vert N ( m ) \vert}$$

represents the intermediate output of each respective AGG 116/PROJ 118 and can be thought of as an average of all the node vectors 112 for the neighbors of node m, and

$${B}_{k} \cdot {h}_{m}^{k - 1}$$

represents the intermediate output of each respective PROJ 120 and can be thought of as the previous layer embedding of node m scaled with a bias Bₖ and/or as a trainable weight matrix of a self-loop activation for node m.

As further shown in FIG. 1, the output of the PROJ/AGG operations for the node vector 112 of the target node 204 (node m) in the last layer (GNN Layer 3) defines the representation vector 114. Thus, the representation vector 114 is the hidden, latent RAG-GNN hybrid system 100 representation for node m. In some embodiments, the representation vector 114 can be provided to a feed forward neural network tower 122 (also referred to as the member tower) to generate an output vector 124 for node m. In some embodiments, the feed forward neural network tower 122 is a fully connected neural network having any number of internal interaction layers (not separately shown), although other configurations are within the contemplated scope of this disclosure. Thus, in some embodiments, the output vector 124 for node m is the numerical final set of values (the representation) of the last layer (or final layer) of the feed forward neural network tower 122.

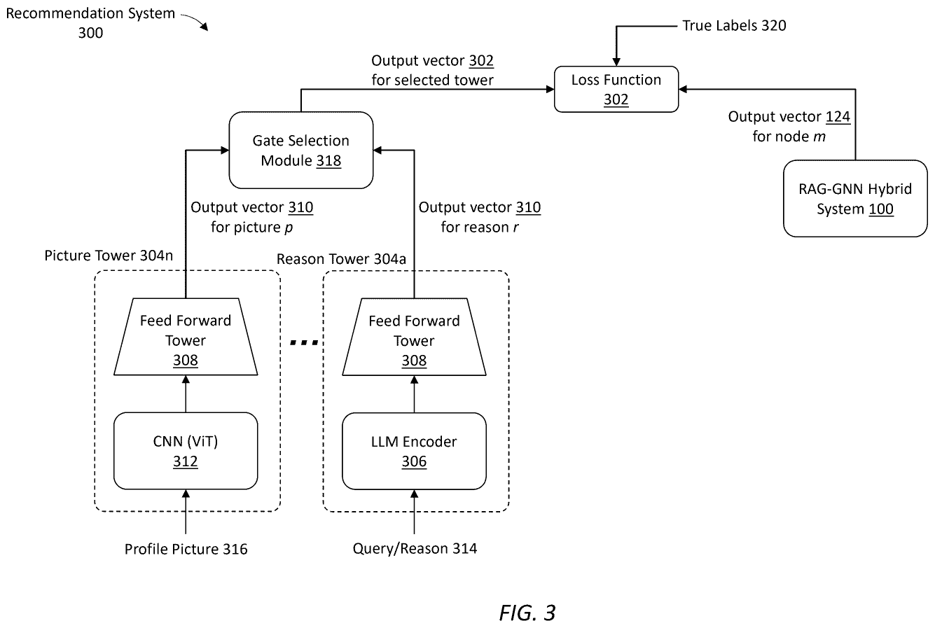

FIG. 3 depicts a block diagram for a recommendation system 300 in accordance with one or more embodiments. In some embodiments, the recommendation system 300 includes and/or is communicatively coupled to the RAG-GNN hybrid system 100 (refer to FIG. 1). In some embodiments, the RAG-GNN hybrid system 100 is coupled to a loss function 302 of the recommendation system 300. More specifically, in some embodiments, the output vector 124 for node m from the feed forward neural network tower 122 is coupled to the loss function 302.

In some embodiments, the RAG-GNN hybrid system 100 and/or the feed forward neural network tower 122 is coupled, via the loss function 302, to one or more other feed forward neural network towers 304 (as shown, “Reason Tower 304a”, . . . , “Picture Tower 304n”, for some predetermined number n of additional towers). While the recommendation system 300 is shown having two feed forward neural network towers 304, this is for ease of discussion only. It should be understood that the recommendation system 300 can include any number of feed forward neural network towers 304 and all such configurations are within the contemplated scope of this disclosure.

In some embodiments, each of the feed forward neural network towers 304 is configured to receive and process a different type and/or modality of input data. For example, in some embodiments, the reason tower 304a is configured to receive a query and/or reason 314, while the picture tower 304n is configured to receive a profile picture 316 (as shown). In some embodiments, query/reason 314 is a user-provided query, such as the statement “Please recommend me some connections for people that share my interest in machine learning”. In some embodiments, profile picture 314 is a profile picture of a member(s) of a network. Other configurations are possible and example configurations are provided below for illustration only.

In some embodiments, a given tower of the feed forward neural network towers 304 can include an LLM encoder 306 and/or a feed forward tower 308. Such a configuration is suited to textual inputs, or to input data that can readily be transformed into textual data. The LLM encoders 306 can be configured to generate embeddings in a similar manner as the LLM encoder 108 (refer to FIG. 1). Similarly, the feed forward tower 308 can be configured to generate an output vector in a similar manner as the feed forward neural network tower 122 (refer to FIG. 1). Thus, in some embodiments, one or more of the feed forward neural network towers 304 can be configured to transform textual input data using the respective LLM encoder 306 into embeddings that can be fed into the respective feed forward tower 308 to generate output vectors 310.

In some embodiments, a given tower of the feed forward neural network towers 304 can include a convolutional neural network (CNN) 312 and/or a feed forward tower 308. Such a configuration is suited to image-based (graphical) inputs. The CNN 312 can be configured to convert image data into vector feature data using known techniques. CNNs are well-suited to convert image data to a feature space because of their ability to learn hierarchical representations of image data through the use of convolutional and pooling layers. Additionally, or alternatively, the CNN 312 can be replaced by (or supplemented with) a Transformer-based model (not separately shown), such as, for example, a vision Transformer (ViT). A ViT can be configured using known techniques to model an input image as a sequence of patches and can leverage a transformer encoder to learn representations for each patch. These can then be aggregated into an output vector feature representation.

While not separately shown, a given tower of the feed forward neural network towers 304 can include any combination of LLM encoders, feed forward towers, CNNs, and/or ViTs, depending on the encoding requirements of the respective input data. For example, the Picture Tower 304n can further include an LLM encoder 306 in embodiments where the profile picture 316 is combined with non-image data, such as contextual data for the respective image. Such data could include, for example, whether the respective image is the same (or substantially the same within any predetermined threshold) as another profile picture of another member of the network (indicating that the profile might be a fake copy of another member's profile, or vice versa) and/or whether the respective image is available in predetermined public image databases (indicating that the profile might be AI-generated).

In some embodiments, the output vectors 310 are passed to a gate selection module 318. In some embodiments, the gate selection module 318 is coupled to each of the feed forward neural network towers 304. In some embodiments, the gate selection module 318 is configured to select a subset (all, one, or some, as desired) of the feed forward neural network towers 304 and/or output vectors 310 for comparison against the output vector 124 by the loss function 302.

In some embodiments, the loss function 302 is trained over true labels 320 during a training phase to score respective output vector 124-output vector 302 pairs. In this manner, the loss function 302 can leveraged during an inference phase to recommend a new edge 214 (refer to FIG. 2) for a respective member m. In other words, the loss function 302 can be leveraged to identify and recommend appropriate members (new edges 214) from the input graph 200.

In some embodiments, the true labels 320 include positive training data and negative training data. Let m be a member (corresponding, for example, to target node 204) of a network, c be a candidate connection (e.g., a candidate for recommending a new edge 214), l be a label equal to 1 if m sends an invitation to connect to c, and equal to 0 otherwise, and r be the reason for recommending c to m. Reason r can be the result of a user query (e.g., when Alice issues a query, “Show me people who can mentor me in machine learning”, the reason r can be “Bob is a recommended contact because Bob is knowledgeable in NIL”) or, when a user query is not provided, the reason r can be the highest scoring reason for a respective recommendation (e.g., Bob is recommended to Alice with the reason, “Because you like machine learning”).

In some embodiments, the true labels 320 are 4-tuples of the form <m, c, l, r>. Thus, in some embodiments, positive training data includes a plurality of 4-tuples having the form <m, c, 1, r> and negative training data includes a plurality of 4-tuples having the form <m, c, 0, r>. For example, a 4-tuple such as <Alice, Bob, 1, “Because you like machine learning”> means that Alice sent an invitation to Bob when Bob was impressed as a recommendation to Alice under the reason “Because you like machine learning”. Similarly, a tuple like <Parag, Ankan, “Show me people who are interested in stargazing”, 1> would mean that Parag sent an invitation to Ankan when Parag received Ankan as a recommended contact in response to Parag's query: “Show me people who are interested in stargazing”.

Conversely, negative training data might include a 4-tuple such as <Alice, Bob, 0, “Because you like machine learning”>, which means that Alice did not send an invitation to Bob when Bob was impressed as a recommendation to Alice under the reason “Because you like machine learning”. In some embodiments, negative training data only includes 4-tuples having the form <m, c, 0, r> after a predetermined period of time has elapsed since c was impressed to m. This delay period could be, for example, 1 day, 7 days, 30 days, etc. In other words, negative training data captures impressions which did not result in new connections (new edges 214, refer to FIG. 2) after a predetermined amount of time. In addition, or alternatively, negative training data can be generated by randomly sampling N members from the entire network as, for sufficiently sized networks (e.g., at least 1000s, if not millions of members), a random member n in N is probabilistically unlikely (against any predetermined threshold accuracy) to be a positive match for m.

In some embodiments, loss function 302 is trained by minimizing the standard binary cross-entropy loss according to the following formula (2):

$$L = {\sum }_{tuples} - log ( \frac{{e}^{< {e}_{r} \cdot {e}_{m} > / τ}}{{e}^{< {e}_{r} \cdot {e}_{m} > / τ} + {\sum }_{neg} {e}^{< {e}_{r} \cdot {e}_{m} > / τ}} ) \qquad ( 2 )$$

where τ∈[0.01, ∞] in the loss equation L is a temperature parameter which helps with the calibration of our model.

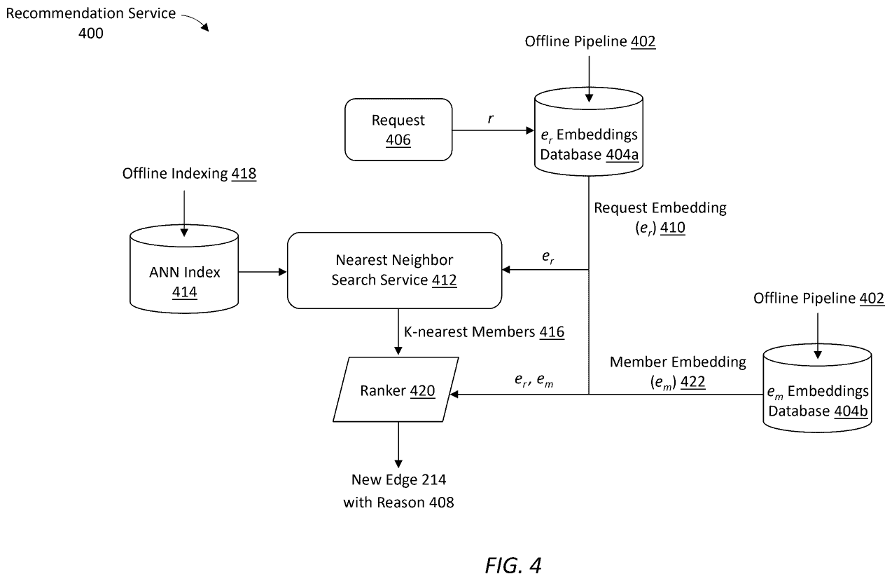

FIG. 4 depicts a block diagram for a recommendation service 400 in accordance with one or more embodiments. In some embodiments, the recommendation service 400 includes and/or is communicatively coupled to the RAG-GNN hybrid system 100 (refer to FIG. 1) and/or the recommendation system 300 (refer to FIG. 3). In some embodiments, the RAG-GNN hybrid system 100 and/or the recommendation system 300 are used as an offline pipeline 402 to populate various embedding databases 404 of the recommendation service 400 such as, for example, an eᵣ embeddings database 404a and an eₘ embeddings database 404b. For example, in some embodiments, the RAG-GNN hybrid system 100 is leveraged continuously, periodically, and/or intermittently generate output vectors 124 for a plurality of nodes 202. In some embodiments, these generated output vectors 124 (each a member embedding eₘ for some node 202) can be stored in the eₘ embeddings database 404b. Similarly, in some embodiments, the recommendation system 300 is leveraged continuously, periodically, and/or intermittently generate output vectors 310 and/or output vectors 302. In some embodiments, output vectors 310 for reasons r (that is, a reason embedding eᵣ for some reason r generated by the reason tower 304a) can be stored in the eᵣ embeddings database 404a. Other embedding databases (not separately shown) can be similarly populated in an offline workflow using other towers (e.g., picture tower 304n, etc.).

In some embodiments, the recommendation service 400 includes an online portion whereby a request 406 (also denoted request r) can be provided by a user and, in response, a new edge 214 can be recommended to the user. While not meant to be particularly limited, the request 406 can include a user-supplied text entry, such as, for example, “Show me recommendations for other members having an interest in aviation”. In some embodiments, the new edge 214 is provided to the respective user alongside a reason 408. In some embodiments, the reason 408 corresponds to the request 406. In some embodiments, the reason 408 is the textual input corresponding to the embedding for the respective request 406. For example, the reason 408 might include the text, “Bob is a recommended connection because Bob has an interest in aviation”. In some embodiments, the reason 408 corresponds in part to the request 406, but includes additional rationale. For example, the reason 408 might include the text, “Bob is a recommended connection because Bob has an interest in aviation, Bob lives in your community, and you and Bob are alumni of College ABC”. Such an approach is useful when the field of candidates for a given request 406 is very large (that is, when the request 406 is broad enough to allow for more than a predetermined number of candidates).

An example workflow through the online portion of the recommendation service 400 is now illustrated. First, a request 406 is received by the recommendation service 400. The request 406 is then searched against the eᵣ embeddings database 404a to retrieve the corresponding request embedding (eᵣ) 410. The retrieved request embedding (eᵣ) 410 is provided to a nearest neighbor search service 412.

In some embodiments, the nearest neighbor search service 412 is configured poll (search) an approximate nearest-neighbor (ANN) index 414 to retrieve the K-nearest members 416 for the retrieved request embedding (eᵣ) 410. As used herein, the “K-nearest” members 416 refers to the K closest members to the retrieved request embedding (eᵣ) 410 within an embedding space measured according to any predetermined distance measure such as, for example, Euclidean distance, for any predetermined value for K. K need not be a fixed value and the particular distance measure chosen need not be limited. For example, the K-nearest members 416 can include K (for any arbitrary value for K) members within a predetermined Euclidean distance from the retrieved request embedding (eᵣ) 410.

In some embodiments, the ANN index 414 is an ANN index over eₘ. The ANN index 414 can be populated using an offline pipeline (as shown, “offline indexing 418”) in a similar manner as discussed with respect to the offline pipeline 402, except that the ANN index 414 can be built using known indexing systems once a population of eₘ embeddings is known (via, e.g., the RAG-GNN hybrid system 100 as described previously).

In some embodiments, the K-nearest members 416 are provided to a ranker 420. In some embodiments, the ranker 420 provides, responsive to receiving the K-nearest members 416, a final recommendation (that is, a new edge 214). In some embodiments, the ranker 420 also receives (or fetches) the request embedding (eᵣ) 410 and a member embedding (eₘ) 422 from the eᵣ embeddings database 404a and the eₘ embeddings database 404b, respectively. In some embodiments, the ranker 420 computes an additional feature from the embeddings eᵣ and eₘ. In some embodiments, the additional feature includes the dot product and/or cosine similarity of eᵣ and eₘ. In this manner, one or more additional features can be relied upon in generating the new edge 214. Thus, in some embodiments, the ranker 420 can determine a recommendation for a new edge 214 based in part on the K-nearest members 416 (a first feature) and the dot product and/or cosine similarity of eᵣ and eₘ (a second feature).

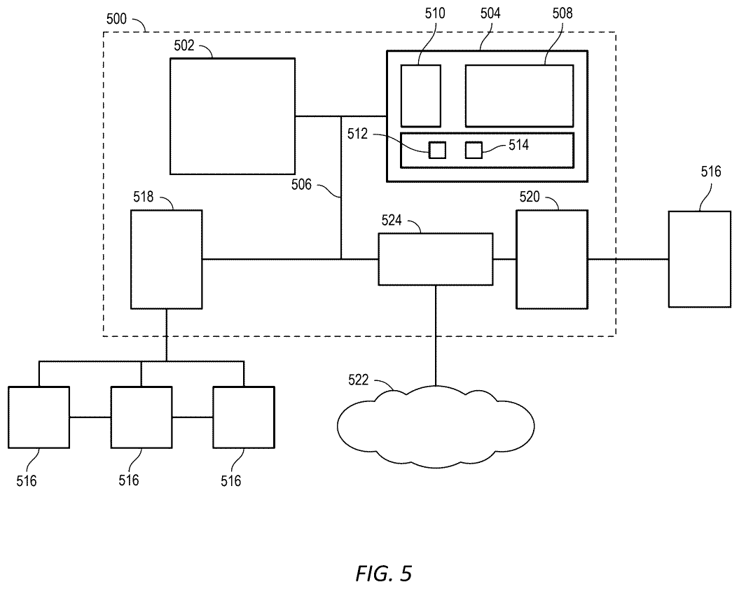

FIG. 5 illustrates aspects of an embodiment of a computer system 500 that can perform various aspects of embodiments described herein. In some embodiments, the computer system(s) 500 can implement and/or otherwise be incorporated within or in combination with the RAG-GNN hybrid system 100 (refer to FIG. 1), the recommendation system 300 (refer to FIG. 3), and/or the recommendation service 400 (refer to FIG. 4). In some embodiments, a computer system 500 can be implemented server-side. For example, a remote computer system 500 can be configured to receive a request (e.g., request 406, such as the text, “please recommend members that can mentor me in machine learning”, and in response, to respond with a recommendation (e.g., new edge 214, with or without reason 408, such as the text, “Bob is recommended because Bob has an extensive experience building machine learning architectures”).

The computer system 500 includes at least one processing device 502, which generally includes one or more processors or processing units for performing a variety of functions, such as, for example, completing any portion of the RAG-GNN hybrid system 100, the input graph 200, the recommendation system 300, and/or the recommendation service 400 described previously. Components of the computer system 500 also include a system memory 504, and a bus 506 that couples various system components including the system memory 504 to the processing device 502. The system memory 504 may include a variety of computer system readable media. Such media can be any available media that is accessible by the processing device 502, and includes both volatile and non-volatile media, and removable and non-removable media. For example, the system memory 504 includes a non-volatile memory 508 such as a hard drive, and may also include a volatile memory 510, such as random access memory (RAM) and/or cache memory. The computer system 500 can further include other removable/non-removable, volatile/non-volatile computer system storage media.

The system memory 504 can include at least one program product having a set (e.g., at least one) of program modules that are configured to carry out functions of the embodiments described herein. For example, the system memory 504 stores various program modules that generally carry out the functions and/or methodologies of embodiments described herein. A module or modules 512, 514 may be included to perform functions related to the block diagrams 100, 110, 300, and 400 as described previously herein. The computer system 500 is not so limited, as other modules may be included depending on the desired functionality of the computer system 500. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 502 can also be configured to communicate with one or more external devices 516 such as, for example, a keyboard, a pointing device, and/or any devices (e.g., a network card, a modem, etc.) that enable the processing device 502 to communicate with one or more other computing devices. Communication with various devices can occur via Input/Output (I/O) interfaces 518 and 520.

The processing device 502 may also communicate with one or more networks 522 such as a local area network (LAN), a general wide area network (WAN), a bus network and/or a public network (e.g., the Internet) via a network adapter 524. In some embodiments, the network adapter 524 is or includes an optical network adaptor for communication over an optical network. It should be understood that although not shown, other hardware and/or software components may be used in conjunction with the computer system 500. Examples include, but are not limited to, microcode, device drivers, redundant processing units, external disk drive arrays, RAID systems, and data archival storage systems, etc.

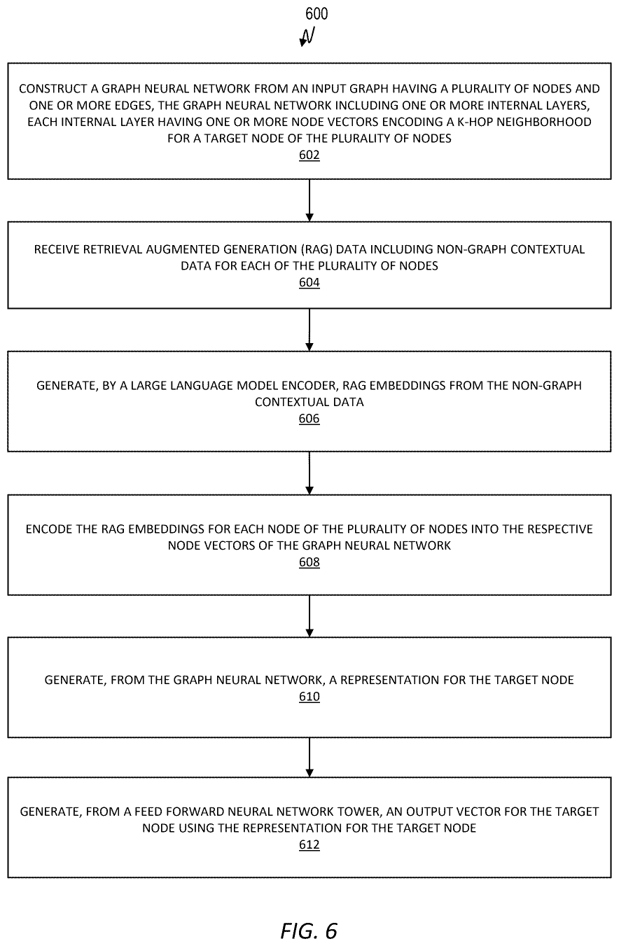

Referring now to FIG. 6, a flowchart 600 for leveraging retrieval augmented generation over a graph neural network for edge building and the generation of reason-aware graph recommendations is generally shown according to an embodiment. The flowchart 600 is described with reference to FIGS. 1 to 5 and may include additional steps not depicted in FIG. 6. Although depicted in a particular order, the blocks depicted in FIG. 6 can be, in some embodiments, rearranged, subdivided, and/or combined.

At block 602, the method includes constructing a graph neural network (e.g., GNN 104) from an input graph (e.g., input graph 200) having a plurality of nodes (e.g., nodes 202) and one or more edges (e.g., edges 206). The graph neural network includes one or more internal layers (e.g., GNN layer 1, . . . 2, . . . 3), each internal layer having one or more node vectors (e.g., node vectors 112) encoding a K-hop neighborhood for a target node (e.g., target node 204) of the plurality of nodes.

At block 604, the method includes receiving retrieval augmented generation (RAG) data (e.g., RAG data 106) including non-graph contextual data for each of the plurality of nodes.

At block 606, the method includes generating, by a large language model encoder (e.g., LLM encoder 108), RAG embeddings (e.g., RAG embeddings 110) from the non-graph contextual data.

At block 608, the method includes encoding the RAG embeddings for each node of the plurality of nodes into the respective node vectors of the graph neural network (refer to FIG. 1).

At block 610, the method includes generating, from the graph neural network, a representation (e.g., RAG-GNN representation 114) for the target node.

At block 612, the method includes generating, from a feed forward neural network tower (e.g., feed forward neural network tower 122), an output vector (e.g., output vector 124) for the target node using the representation for the target node.

In some embodiments, K is two (refer to FIG. 2) and the graph neural network comprises three internal layers (refer to FIG. 1). In some embodiments, the three internal layers include a first internal layer encoding a 2-hop neighborhood for the target node, a second internal layer encoding a 1-hop neighborhood for the target node, and a third internal layer encoding a 2-hop neighborhood for the target node.

In some embodiments, the method includes coupling the output vector to a loss function with a second output vector from a second feed forward neural network tower (refer to FIG. 3).

In some embodiments, the second feed forward neural network tower is coupled to a second large language model encoder. In some embodiments, an input to the second feed forward neural network tower includes an embedding, from the second large language model, of a query comprising textual data.

In some embodiments, the second feed forward neural network tower is coupled to one or more of a CNN or a ViT. In some embodiments, an input to the second feed forward neural network tower includes an embedding, from one of the CNN and the ViT, of image data.

In some embodiments, the method includes selecting, via a gate selection module, the second output vector from the second feed forward neural network tower from a plurality of additional feed forward neural network towers having outputs coupled to the gate selection module (refer to FIG. 3).

In some embodiments, the method includes storing a plurality of output vectors for a plurality of target nodes in a first embedding database and storing a plurality of second output vectors from the second feed forward neural network tower in a second embedding database (refer to FIG. 4).

In some embodiments, the method includes receiving a request from a user and providing, responsive to the request, a recommendation to the user (refer to FIG. 4). In some embodiments, the recommendation includes a new edge in the graph neural network.

In some embodiments, the method includes retrieving an embedding from the second embedding database corresponding to the request, determining a set of K-nearest members for the retrieved embedding from the second embedding database, and retrieving an embedding from the first embedding database corresponding to each member of the set of K-nearest members (refer to FIG. 4). In some embodiments, the recommendation is generated based on the respective retrieved embeddings from the first embedding database and the second embedding database (refer to ranker 420).

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the present disclosure are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the present disclosure may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Embodiments of the present disclosure may be implemented as or as part of a system, a method, and/or a computer program product at any possible technical detail level of integration. The computer program product may include a computer readable storage medium (or media) having computer readable program instructions thereon for causing a processor to carry out aspects of the present disclosure.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method comprising:
constructing a graph neural network from an input graph comprising a plurality of nodes and one or more edges, the graph neural network comprising one or more internal layers, each internal layer comprising one or more node vectors encoding a K-hop neighborhood for a target node of the plurality of nodes;
receiving retrieval augmented generation (RAG) data comprising non-graph contextual data for each of the plurality of nodes;
generating, by a large language model encoder, RAG embeddings from the non-graph contextual data;
encoding the RAG embeddings for each node of the plurality of nodes into the respective node vectors of the graph neural network;
generating, from the graph neural network, a representation for the target node; and
generating, from a feed forward neural network tower, an output vector for the target node using the representation for the target node.

2. The method of claim 1, wherein K is two and the graph neural network comprises three internal layers, the three internal layers comprising a first internal layer encoding a 2-hop neighborhood for the target node, a second internal layer encoding a 1-hop neighborhood for the target node, and a third internal layer encoding a 2-hop neighborhood for the target node.

3. The method of claim 1, further comprising coupling the output vector to a loss function with a second output vector from a second feed forward neural network tower.

4. The method of claim 3, wherein the second feed forward neural network tower is coupled to a second large language model encoder, and wherein an input to the second feed forward neural network tower comprises an embedding, from the second large language model, of a query comprising textual data.

5. The method of claim 3, wherein the second feed forward neural network tower is coupled to one or more of a convolutional neural network (CNN) or a vision Transformer (ViT), and wherein an input to the second feed forward neural network tower comprises an embedding, from one of the CNN or the ViT, of image data.

6. The method of claim 3, further comprising selecting, via a gate selection module, the second output vector from the second feed forward neural network tower from a plurality of additional feed forward neural network towers having outputs coupled to the gate selection module.

7. The method of claim 3, further comprising:
storing a plurality of output vectors for a plurality of target nodes in a first embedding database; and
storing a plurality of second output vectors from the second feed forward neural network tower in a second embedding database.

8. The method of claim 7, further comprising:
receiving a request from a user; and
providing, responsive to the request, a recommendation to the user, wherein the recommendation comprises a new edge in the graph neural network.

9. The method of claim 8, further comprising:
retrieving an embedding from the second embedding database corresponding to the request;
determining a set of K-nearest members for the retrieved embedding from the second embedding database; and
retrieving an embedding from the first embedding database corresponding to each member of the set of K-nearest members;
wherein the recommendation is generated based on the respective retrieved embeddings from the first embedding database and the second embedding database.

10. A system having a memory, computer readable instructions, and one or more processors for executing the computer readable instructions, the computer readable instructions controlling the one or more processors to perform operations comprising:
constructing a graph neural network from an input graph comprising a plurality of nodes and one or more edges, the graph neural network comprising one or more internal layers, each internal layer comprising one or more node vectors encoding a K-hop neighborhood for a target node of the plurality of nodes;
receiving retrieval augmented generation (RAG) data comprising non-graph contextual data for each of the plurality of nodes;
generating, by a large language model encoder, RAG embeddings from the non-graph contextual data;
encoding the RAG embeddings for each node of the plurality of nodes into the respective node vectors of the graph neural network;
generating, from the graph neural network, a representation for the target node; and
generating, from a feed forward neural network tower, an output vector for the target node using the representation for the target node.

11. The system of claim 10, wherein K is two and the graph neural network comprises three internal layers, the three internal layers comprising a first internal layer encoding a 2-hop neighborhood for the target node, a second internal layer encoding a 1-hop neighborhood for the target node, and a third internal layer encoding a 2-hop neighborhood for the target node.

12. The system of claim 10, wherein the one or more processors perform operations further comprising coupling the output vector to a loss function with a second output vector from a second feed forward neural network tower.

13. The system of claim 12, wherein the second feed forward neural network tower is coupled to a second large language model encoder, and wherein an input to the second feed forward neural network tower comprises an embedding, from the second large language model, of a query comprising textual data.

14. The system of claim 12, wherein the second feed forward neural network tower is coupled to one or more of a convolutional neural network (CNN) and a vision Transformer (ViT), and wherein an input to the second feed forward neural network tower comprises an embedding, from one of the CNN and the ViT, of image data.

15. The system of claim 12, wherein the one or more processors perform operations further comprising selecting, via a gate selection module, the second output vector from the second feed forward neural network tower from a plurality of additional feed forward neural network towers having outputs coupled to the gate selection module.

16. The system of claim 12, wherein the one or more processors perform operations further comprising:
storing a plurality of output vectors for a plurality of target nodes in a first embedding database; and
storing a plurality of second output vectors from the second feed forward neural network tower in a second embedding database.

17. The system of claim 16, wherein the one or more processors perform operations further comprising:
receiving a request from a user; and
providing, responsive to the request, a recommendation to the user, wherein the recommendation comprises a new edge in the graph neural network.

18. The system of claim 17, wherein the one or more processors perform operations further comprising:
retrieving an embedding from the second embedding database corresponding to the request;
determining a set of K-nearest members for the retrieved embedding from the second embedding database; and
retrieving an embedding from the first embedding database corresponding to each member of the set of K-nearest members;
wherein the recommendation is generated based on the respective retrieved embeddings from the first embedding database and the second embedding database.

19. A computer program product comprising a computer readable storage medium having program instructions embodied therewith, the program instructions executable by one or more processors to cause the one or more processors to perform operations comprising:
constructing a graph neural network from an input graph comprising a plurality of nodes and one or more edges, the graph neural network comprising one or more internal layers, each internal layer comprising one or more node vectors encoding a K-hop neighborhood for a target node of the plurality of nodes;
receiving retrieval augmented generation (RAG) data comprising non-graph contextual data for each of the plurality of nodes;
generating, by a large language model encoder, RAG embeddings from the non-graph contextual data;
encoding the RAG embeddings for each node of the plurality of nodes into the respective node vectors of the graph neural network;
generating, from the graph neural network, a representation for the target node; and
generating, from a feed forward neural network tower, an output vector for the target node using the representation for the target node.

20. The computer program product of claim 19, wherein K is two and the graph neural network comprises three internal layers, the three internal layers comprising a first internal layer encoding a 2-hop neighborhood for the target node, a second internal layer encoding a 1-hop neighborhood for the target node, and a third internal layer encoding a 2-hop neighborhood for the target node.
